(19) United States
(12) Patent Application Publication
(10) Pub. No.: US 2015/0255938 A1
(43) Pub. Date: Sep. 10, 2015

(54) POWER DISTRIBUTION TRACK SYSTEM

(71) Applicant: KONINKLIJKE PHILIPS N.V., Eindhoven (NL)

(72) Inventors: Matthias Wendt, Wurselen (DE); Harald Josef Gunther Radermacher, Aachen (DE)

(21) Appl. No.: 14/441,644

(22) PCT Filed: Oct. 25, 2013
(86) PCT No.: PCT/IB2013/059661

§ 371 Date: May 8, 2015

Related U.S. Application Data
(60) Provisional application No. 61/724,373, filed on Nov. 9, 2012.

(51) Int. Cl. H01R 25/14; H01R 13/66

(52) U.S. Cl. CPC H01R 25/14; H01R 13/6683; H01R 25/142

(57) ABSTRACT

The invention relates to a power distribution track system, in particular, to a DC power distribution track system, comprising a track (3) with position markers (17) representing positional information being indicative of the respective longitudinal position. The system further comprises an electrical device like a luminair connected to the track (3) at a longitudinal position, wherein the electrical device comprises a reading unit for reading out the positional information represented by the position marker at the longitudinal position at which the electrical device is connected. Since the reading unit reads out the positional information at the respective longitudinal position represented by the respective position marker, positional information can be provided, which can be used for automatically determining the longitudinal position of the electrical device, especially without requiring an installer installing the electrical device to determine the position of the electrical device.

### FIELD OF THE INVENTION

The invention relates to a power distribution track system for distributing power via a track. The invention relates further to a track, an electrical device, an electrical connector and a position determining device for the power distribution track system. Moreover, the invention relates to a position determining method and a position determining computer program for determining the position of an electrical device along a track of a power distribution track system.

### BACKGROUND OF THE INVENTION

In the power distribution track system in accordance with the EMerge standard DC power is distributed via power carrying tracks to which electrical devices like lighting devices are attached. After the electrical devices have been attached to the tracks, the positions of the electrical devices along the tracks are unknown. However, these positions may be useful for, for instance, controlling purposes, i.e. for controlling a respective electrical device depending on its position.

### SUMMARY OF THE INVENTION

It is an object of the present invention to provide a power distribution track system for distributing power via a track, which allows for a determination of a position of an electrical device connected to the track. It is a further object of the present invention to provide a track, an electrical device, an electrical connector and a position determining device of the power distribution track system. Moreover, it is an object of the present invention to provide a position determining method and a position determining computer program for determining the position of an electrical device along a track of the power distribution track system.

In a first aspect of the present invention a power distribution track system for distributing power via a track is presented, wherein the power distribution track system comprises:
the track, wherein the track comprises position markers at different longitudinal positions along the track, wherein the position markers represent positional information being indicative of the respective longitudinal position,
an electrical device connected to the track at a longitudinal position, wherein the electrical device comprises a reading unit for reading out the positional information represented by the position marker at the longitudinal position at which the electrical device is connected,

Since the track comprises the position markers at the different longitudinal positions along the track, wherein the reading unit reads out the positional information at the respective longitudinal position represented by the respective position marker, positional information can be provided, which can be used for automatically determining the longitudinal position of the electrical device, especially without requiring an installer installing the electrical device to determine the position of the electrical device.

The position markers arranged along the different longitudinal positions along the track can be regarded as forming a coding structure. The coding structure may be fixed to the track, which may also be regarded as being a beam, before installation of the power distribution track system or even during manufacturing of the track. Moreover, the power distribution track system can be arranged at a suspended ceiling of a room of a building, wherein the track can be adapted to carry the suspended ceiling. For instance, it can comprise protrusions for supporting ceiling elements of the suspended ceiling.

The power distribution track system is preferentially adapted to provide DC power, wherein the electrical device is preferentially a lighting device and the power distribution track system is preferentially a lighting system. The electrical device can also be another device like a sensor device or a ventilation device.

It is preferred that the position markers form digital codes for indicating the respective longitudinal position. Thus, a digital code can be attached to the track.

In an embodiment the digital code of a position marker is formed by a sequence of electrically conductive regions and electrically insulated regions. In this case the reading unit is adapted to detect the electrically conductive and electrically insulated regions for reading out the positional information represented by the position marker. Thus, the reading unit can comprise contacts for reading a code that is represented by blank or covered patterns. The electrically conductive regions may represent a “1” and the electrically insulated regions may represent a “0” or vice versa for coding the respective longitudinal position.

The positions markers may be formed by a code strip longitudinally arranged along the track, wherein the code strip comprises an electrically conductive layer and an electrically insulating layer partly covering the electrically conductive layer for forming the sequence of electrically conductive and electrically insulated regions. The electrically conductive layer is preferentially a metallic layer, and the track preferentially comprises an electrical conductor, which in an embodiment may be regarded as being a bus bar component conductor, for distributing the power, wherein the electrically conductive layer is preferentially electrically connected with the electrical conductor.

In an embodiment for each position marker a minimal number of electrically conductive regions or electrically insulated regions is at least present, wherein the minimal number is larger than one. This is especially preferred, if the power supply also goes via contacts of the reading unit.

The digital code of a position marker may also be formed by a sequence of a) hole positions or indentation positions and b) non-hole positions or non-indentation positions. The holes or indentations are preferentially generated by machining away a material, whereas at a non-hole position or non-indentation position the material has not been machined away. The material is, for instance, a carrier material of the track or another material, which has been attached to the track.

The reading unit can be adapted to read out the positional information represented by the respective position marker mechanically, electrically, optically or magnetically. In particular, the reading unit can be adapted to read the digital code electro-mechanically. If the digital code of a position marker is formed by a sequence of a) hole positions or indentation positions and b) non-holes positions or non-indentation positions, the reading unit can comprise spring contacts that are configured to only engage where the corresponding material has not been removed. The reading unit can also comprise other kinds of contacts like brushes, contacting needles, et cetera. The reading unit may also comprise switching contacts to “feel” the valley where the material has been removed. The reading unit can also be adapted to read the position markers capacitively or inductively.

For optically reading out the positional information the reading unit can comprise optical means like a reflective light barrier, a camera, a line photodetector, an array of photosensitive elements, et cetera. For magnetically reading out the positional information the reading unit may comprise magnetic means like an inductor, a Hall effect sensor, a magneto-resistive sensor, et cetera. For mechanically reading out the positional information the reading unit can comprise switches.

The digital code of a position marker can be formed by a sequence of electrically conductive regions and electrically insulated regions, wherein the reading unit can comprise electrical contacts for contacting the electrically conductive and electrically insulated regions for determining which region of the respective position marker is electrically conductive and which region of the respective position marker is electrically insulated for reading out the positional information represented by the position marker.

The digital code at a longitudinal position is preferentially formed by a sequence of coded bits, wherein the digital code is perpendicularly arranged with respect to the longitudinal direction of the track. For instance, the sequence of electrically conductive and electrically insulated regions representing bits coding a respective longitudinal position on the track is perpendicularly arranged with respect to the longitudinal direction of the track.

The position markers preferentially form a Gray code. According to the Gray code, two successive values, i.e. two values indicated by two successive Gray code values, differ by one bit only. This has the advantage that large position determination errors are very unlikely to occur.

If the position markers form digital codes for indicating the respective longitudinal position, wherein the digital code of a position marker is formed by a sequence of electrically conductive regions and electrically insulated regions and wherein for each position marker a minimal number of electrically conductive regions or electrically insulated regions is at least present, wherein the minimal number is larger than one, the position markers can form a modified Gray code, in which each Gray code value comprises a minimal number of electrically conductive regions or electrically insulated regions. This is especially preferred, if the power supply also goes via the position coding contacts of the reading unit.

The position markers can be provided on the track, which in an embodiment may also be regarded as being a bus bar component, by attaching a separate element comprising the position markers. For instance, a coding structure may be fixed on a carrying structure of the track for carrying electrical conductors for distributing the power, wherein the coding structure may be glued to the carrying structure like an adhesive tape. The position markers can also be integral with the carrier structure. For instance, the position markers, i.e. a coding structure, may be printed on or pressed into a surface of the carrying structure of the track. The coding structure may also be cut into the surface, for instance, by machining or laser cutting.

In a preferred embodiment, the power distribution track system comprises several tracks, wherein the position markers are further adapted to be indicative of the position of the respective track.

It is further preferred that the electrical device comprises an electrical connector for electrically connecting the electrical device to the track for allowing the electrical device to receive power from or provide power to the track, wherein the electrical connector comprises the reading unit for reading out the positional information represented by the respective position marker. The electrical connector may comprise a latch to fix the electrical connector on the track.

The electrical connector can be regarded as being an electrical connector in accordance with version 1.1 of the EMerge standard, wherein additionally the reading unit is added to this known electrical connector, i.e. the reading unit can be integrated with the electrical connector. In particular, the electrical connector can have a number of additional contacts settling on the code strip, if the electrical connector is attached to the track by, for instance, fixing a latch of the electrical connector. Correspondingly, the position of the electrical connector is preferentially determined as the position of the electrical device. This is especially preferred, if the power distribution track system is in compliance with the EMerge standard.

The track preferentially comprises at least two electrical conductors like copper wires for distributing the power, wherein the electrical connector preferentially comprises at least two contacts for electrically contacting the at least two electrical conductors. The electrical conductors are preferentially fixed to the track, which may also be regarded as being a power bar, and the contacts are preferentially located inside the electrical connector. The electrical device further comprises an electrical load like a lamp that is electrically connected with the electrical connector via further electrical conductors like wires for providing the power from the track via the electrical connector to the electrical load.

The power distribution track system preferentially comprises a position determining device for determining the longitudinal position of the electrical device based on the positional information. The power distribution track system may further comprise a control unit for controlling the electrical device depending on the determined longitudinal position. The control unit can comprise control rules defining the control of the electrical device depending on its longitudinal position.

In a further aspect of the present invention a track for a power distribution track system for distributing power as defined in claim 1 is presented, wherein the track comprises position markers at different longitudinal positions along the track, wherein the position markers represent positional information being indicative of the respective longitudinal position.

In a further aspect of the present invention an electrical device for a power distribution track system for distributing power as defined in claim 1 is presented, wherein the electrical device is adapted to be connected to the track of the power distribution track system at a longitudinal position, wherein the electrical device comprises a reading unit for reading out the positional information at the longitudinal position at which the electrical device is connected.

In a further aspect of the present invention an electrical connector for electrically connecting an electrical device of the power distribution track system as defined in claim 1 to a track of the power distribution track system is presented, especially for allowing the electrical connector to receive power from the track, wherein the electrical connector comprises a reading unit for reading out the positional information at the longitudinal position at which the electrical device is connected.

In a further aspect of the present invention a position determining device for a power distribution track system as defined in claim 1 is presented, wherein the position determining device is adapted to determine the longitudinal position of the electrical device based on the positional information.

In a further aspect of the present invention a position determining method for determining the position of an electrical device along a track of a power distribution track system as defined in claim 1 is presented, wherein the position determining method comprises:
reading out the positional information represented by the position marker at the longitudinal position of the track, at which the electrical device is connected, by the reading unit,
determining the longitudinal position of the electrical device based on the positional information by a position determining device.

In a further aspect of the present invention a position determining computer program for determining the position of an electrical device along a track of a power distribution track system as defined in claim 1 is presented, wherein the position determining computer program comprises program code means for causing a power distribution track system as defined in claim 1 to carry out the steps of the position determining method as defined in claim 14, when the position determining computer program is run on a computer controlling the power distribution track system.

It shall be understood that the power distribution track system of claim 1, the electrical device of claim 11, the electrical connector of claim 12, the position determining device of claim 13, the position determining method of claim 14, and the position determining computer program of claim 15 have similar and/or identical preferred embodiments, in particular, as defined in the dependent claims.

It shall be understood that a preferred embodiment of the invention can also be any combination of the dependent claims with the respective independent claim.

These and other aspects of the invention will be apparent from and elucidated with reference to the embodiments described hereinafter.

### BRIEF DESCRIPTION OF THE DRAWINGS

In the drawings:

FIG. 1 shows schematically and exemplarily an embodiment of a power distribution track system for distributing power via a track,

FIG. 2 shows schematically and exemplarily an embodiment of a track and of an electrical connector of the power distribution track system,

FIG. 3 exemplarily illustrates a coding structure for coding longitudinal positions along the track,

FIG. 4 schematically and exemplarily shows some components of the power distribution track system,

FIG. 5 shows a flowchart exemplarily illustrating an embodiment of a position determining method for determining the position of an electrical device along a track of the power distribution track system,

FIG. 6 exemplarily illustrates a further coding structure for coding longitudinal positions along a track of a power distribution track system,

FIG. 7 shows schematically and exemplarily a further embodiment of a track of a power distribution track system, and

FIG. 8 shows schematically and exemplarily an electrical configuration, which allows a DC power source to use a same electrical conductor for providing DC power and for obtaining information about its position along a track.

### DETAILED DESCRIPTION OF EMBODIMENTS

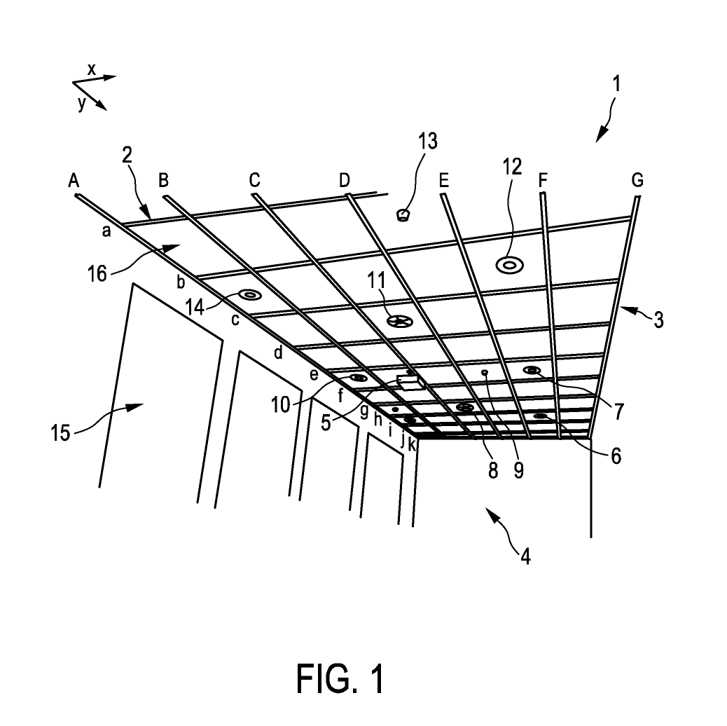

FIG. 1 illustrates a power distribution track system 1 in a room comprising windows 15 and a projection screen 4. The power distribution track system comprises several carrying tracks 3 and several connecting tracks 2. The carrying tracks 3 are arranged at x positions A . . . F and the connecting tracks 2 are arranged at y positions a . . . k. The power distribution track system 1 further comprises electrical devices with an electrical connector and an electrical load. For instance, the power distribution track system 1 comprises lighting devices with electrical connectors and lamps 6, 7, 10, 12, 14, air conditioning devices with electrical connectors and ventilation units 8, 11, a sensing device 9 with an electrical connector and a sensing element 13, a beamer 5 with an electrical connector and a projector 5, et cetera. The power distribution track system can of course also comprise other peripherals. The power distribution track system 1 is arranged at a suspended ceiling of the room shown in FIG. 1, wherein the tracks 3 are adapted to carry ceiling elements 16 of the suspended ceiling.

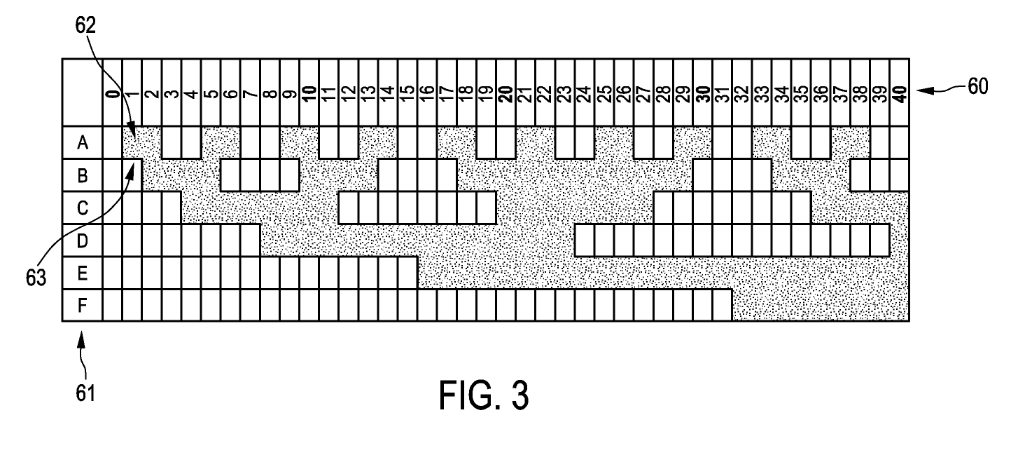

FIG. 3 shows schematically and exemplarily a track 3 in more detail. The track 3 comprises a lower part 40 forming a rail like bottom end with an opening, which is substantially U-shaped in cross section. This lower part 40 comprises two inner electrical conductors 26, 27, which may be copper conductors. An upper part 41 of the track 3 comprises outer electrical conductors 24, 25. In this embodiment the lower inner electrical conductors 26, 27 are not connected to a DC power source and are therefore not used for distributing the power, whereas the outer electrical conductors 24, 25 are connected to a DC power source for distributing DC power along the track 3. An electrical connector 18 is attached to the upper part 41 of the track 3 for electrically connecting the electrical conductors 24, 25 providing the DC power with further electrical conductors 21, 22 electrically connecting the electrical connector 18 with an electrical load of the electrical device. In this example the electrical load is the lamp 14. The electrical connector 18 comprises a latch 23, wherein the electrical connector 18 is adapted such that the electrical connector 18 electrically connects the electrical conductors 24, 25 supplying the DC power with the electrical conductors 21, 22, if the latch 23 fixes the electrical connector 18 on the track 3.

The lower part 40 of the track 3 comprises protrusions 70, 71 for holding the ceiling elements 16 of the suspended ceiling.

The track 3 comprises position markers 17 at different longitudinal positions along the track 3, wherein the position markers 17 represent positional information being indicative of the respective longitudinal position. The electrical connector 18 comprises an integrated reading unit for reading out the positional information at the longitudinal position at which the electrical device is connected. The position markers 17 arranged at the different longitudinal positions along the track 3 can be regarded as forming a coding structure 20 or a code strip. The coding structure 20 may be fixed to the track 3 before installation of the power distribution track system 1 or even during manufacturing the track 3.

The position markers 17 form digital codes for indicating the respective longitudinal position. Thus, by fixing the coding structure 20 to the track 3 a digital code has been attached to the track 3. The digital code of a position marker 17 is formed by a sequence of electrically conductive regions and electrically insulated regions, wherein the reading unit is adapted to detect the electrically conductive and electrically insulated regions for reading out the positional information represented by the respective position marker 17. In this embodiment, the electrically conductive regions represent a “1” and the electrically insulated regions represent a “0” for coding the respective longitudinal position.

The coding structure 20 comprises an electrically conductive layer 43 and an electrically insulating layer 42 partly covering the electrically conductive layer 43 for forming the sequence of electrically conductive and electrically insulated regions. In this embodiment the electrically conductive layer 43 is a metallic layer electrically connected to one of the electrical conductors 24, 25 in the upper part 41 of the track 3. The reading unit comprises contacts for reading the code that is represented by the blank and covered regions.

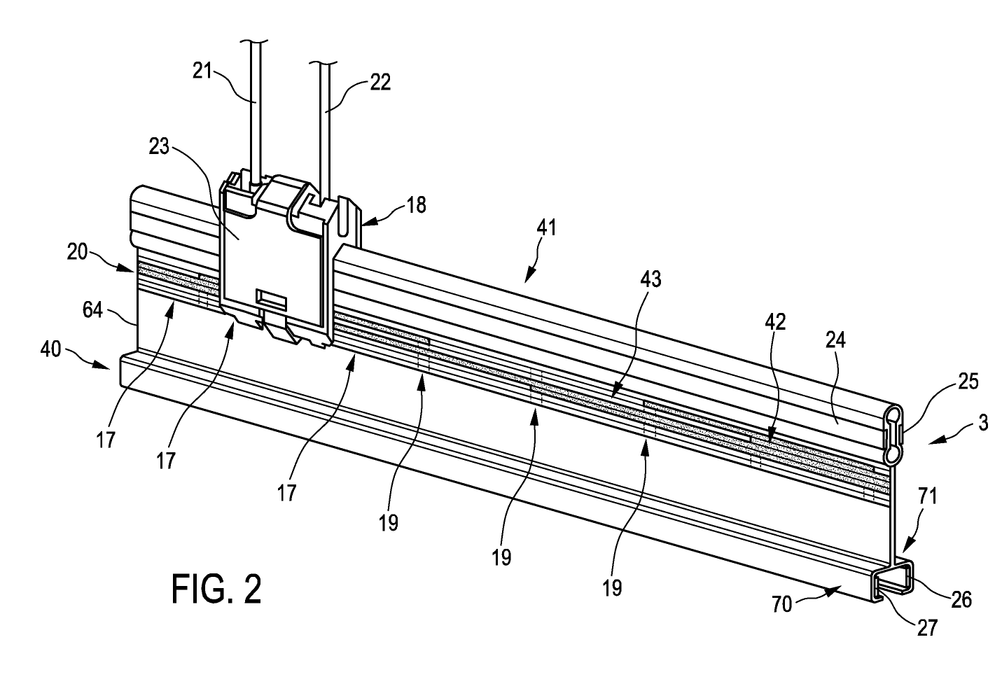

In FIG. 2 imaginary intermediate regions 19 of the coding structure 20 are shown, in order to illustrate the borders between the position markers 17. In the real implementation these intermediate regions 19 are not present. The coding structure 20 is just formed by the electrically conductive layer 43 and the electrically insulating layer 42 partly covering the electrically conductive layer 43 for forming the sequence of electrically conductive and electrically insulated regions.

The digital code at a longitudinal position is preferentially formed by a sequence of coded bits, wherein the digital code is perpendicularly arranged with respect to the longitudinal direction of the track. In this embodiment the sequence of electrically conductive and electrically insulated regions representing bits coding a respective longitudinal position on the track is perpendicularly arranged with respect to the longitudinal direction of the track. Correspondingly, electrical contacts of the reading unit, which, in this embodiment, is integrated in the electrical connector, are arranged consecutively in a line being perpendicularly arranged with respect to the longitudinal direction of the track 3, if the electrical connector is fixed to the track 3, for sensing whether the respective regions are electrically conductive or electrically insulated.

The position markers 17 form a Gray code. According to the Gray code two successive values, i.e. two values indicated by two successive Gray code values, differ by one bit only. This is exemplarily illustrated in FIG. 3.

FIG. 3 illustrates the Gray code values for forty positions 60 and six regions 61 of a position marker, which may be electrically conductive or covered by the electrically insulating layer. FIG. 3 shows blank regions 63 and covered regions 62.

The number of regions in a sequence, i.e. the number of code tracks, is directly related to the number of longitudinal positions that should be uniquely identifiable along the track. In an embodiment the resolution of the position determination is about 30 cm, wherein the length of a track is about 7.62 m. The coding structure can therefore be formed such that 25 positions can be detected along the respective track. A position marker may therefore comprise five regions, which may be covered or blank, for coding up to 32 positions.

In this embodiment the coding structure 20 is a separate element comprising the position markers 17, wherein the coding structure 20 is fixed on a carrying structure 64 of the track 3 for carrying the electrical conductors 24, 25, 26, 27. The coding structure 20 may be glued to the carrying structure 64 like an adhesive tape. In another embodiment the position markers can also be integral with the carrier structure. For instance, the position markers, i.e. the coding structure, may be printed on or pressed into a surface of the carrying structure of the track. The coding structure may also be cut into the surface, for instance, by machining or laser cutting.

The position markers are preferentially further adapted to indicate the position of the respective track such that the position of the respective electrical device in a first direction can be determined as the longitudinal position along the respective track and the position of the respective electrical device in another second direction, which is orthogonal to the first direction, can be determined by determining the position of the respective track.

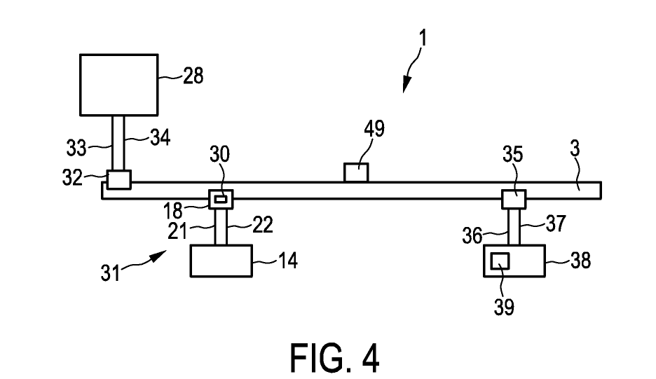

FIG. 4 shows schematically and exemplarily some elements of the power distribution track system, of which some elements were not visible in above FIGS. 1 and 2. As can be seen in FIG. 4, the power distribution system comprises a DC power source 28 electrically connected to one of the tracks 3 via electrical conductors like electrical wires 33, 34 and an electrical connector 32. The DC power source may be regarded as being a power supply module. The electrical connector 32 is configured such that the electrical conductors 33, 34 are electrically connected to the electrical conductors 24, 25 schematically and exemplarily shown in FIG. 2 for distributing the DC power. Moreover, FIG. 4 schematically and exemplarily shows an electrical device being a lighting device 31 comprising the electrical connector 18, the lamp 14 and electrical conductors 21, 22 for electrically connecting the electrical connector 18 to the lamp 14. As schematically indicated in FIG. 4, the electrical connector 18 comprises the reading unit 30 for reading out the positional information coded by the position markers 17 on the track 3.

The power distribution system 1 further comprises a control unit 8 for controlling the electrical devices depending on their respective determined positions. The control unit 38 is electrically connected to the track 3 via electrical conductors 36, 37 and an electrical connector 35. The electrical connector 35 is adapted such that the electrical conductors 36, 37 are electrically connected to the electrical conductors 24, 25 for distributing the DC power.

The control unit 38 comprises control rules defining the control of the respective electrical device depending on its position. For instance, it can be determined from the determined positions which lighting devices are in the neighborhood of a presence sensor device, wherein the control unit 38 can be adapted such that lighting devices in the neighborhood of the presence sensor device are switched on, if the presence sensor device detects the presence of a person, and that these lighting devices are switched off or switched into a low energy mode like a standby mode, if the presence sensor device does not detect the presence of a person. For controlling the electrical devices the control unit 38 can be adapted to communicate with the electrical devices via a wireless data connection like ZigBee or via a wired data connection that may be integrated into the tracks of the power distribution track system. As can be seen in FIG. 4, in this embodiment a position determining device 39, which may also be regarded as being a position determining device, is integrated in the control unit 38. The position determining device 39 is adapted to receive the read out positional information from the respective electrical device via a wired or wireless data connection and to determine the position of the respective electrical device based on the received positional information. In another embodiment the position determining device 39 and the control unit 38 can also be separate units, which may be adapted to communicate with each other via a wireless or wired data connection. Moreover, in another embodiment the position determining device and/or the control unit may not be electrically connected to a track of the power distribution track system, i.e. they may be powered by another power source, wherein these units can still communicate with each other and with the electrical devices via a wired or wireless data connection.

The electrical connector 18 can be an electrical connector in accordance with version 1.1 of the EMerge Standard, wherein additionally the reading unit 30 is added to this known electrical connector, wherein the additional reading unit 30 can be formed by a number of additional contacts settling on the code strip 20, if the electrical connector 18 is attached to the track 3 by fixing the latch 23. Since the reading unit 30 is, in this embodiment, integrated into the electrical connector 18, the position of the electrical connector 18 is determined as the position of the electrical device 31.

The power distribution system 1 may further comprise a coding unit 49 for coding some regions of a position marker, which may not be needed for coding the longitudinal position of the respective electrical device along the respective track. For instance, in an embodiment, only the regions A . . . D schematically and exemplarily shown in FIG. 3 may be used for coding the longitudinal position of the respective electrical device. The regions E, F may remain blank, i.e. may not be covered by the electrically insulating layer 42, wherein the voltage level of these regions E, F may be settable by using the coding unit 49. Regions E, F may therefore be configurable, for instance, during manufacturing, wherein the coding unit 49 may comprise manual switches for setting the voltage level in these regions E, F as desired. In an embodiment, each region E, F can have two possible voltage values representing a “0” and “1”, wherein the voltage of the same region E, F is substantially constant along the length of the respective track. The regions E, F can be used for coding four positions in the second direction being orthogonal to the first direction that is parallel to the tracks 3. Thus, in this example regions A . . . D can be used for determining the position of the respective electrical device in the first direction and regions E, F can be used for determining the position of the respective electrical device in the second direction.

The coding unit 49 can be a separate unit or it can be integrated into an existing unit like a unit interconnecting tracks, which may be present for forwarding the DC power from one track to a next track. The voltage levels in the regions E, F may be alternated, in particular cycled, in a certain way, in order to indicate the respective position in the second direction.

In the described example the regions E, F are electrically insulated from each other and also electrically insulated from the other regions A . . . D, in order to allow the coding unit 49 to set the voltage levels in the regions E, F independently from each other, i.e. in order to provide corresponding electrically separated channels. However, if the coding structure is just provided by using an electrical conductor, which is partly covered by an electrically insulating layer, as shown in FIGS. 2 and 3, the electrical conductor does not necessarily need to be divided into different channels, which are electrically separated from each other.

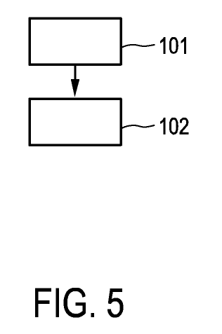

In the following an embodiment of a position determining method for determining the position of an electrical device along a track of a power distribution track system will exemplarily be described with reference to a flowchart shown in FIG. 5.

In step 101, positional information represented by a position marker at a longitudinal position of a track of a power distribution track system, at which an electrical device is connected, is read out by a reading unit. In step 102, the longitudinal position of the electrical device is determined based on the positional information by a position determining device.

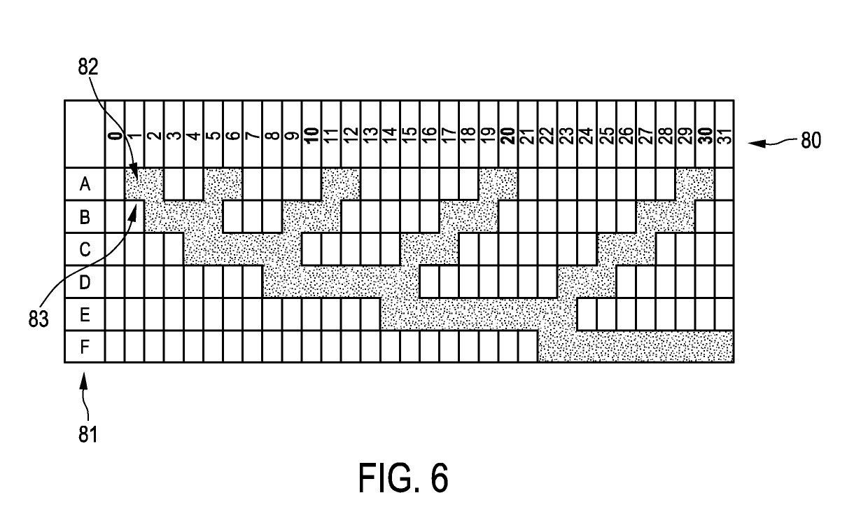

Although FIG. 3 shows schematically and exemplarily a certain Gray code, the position markers can code the respective longitudinal position also by using another code. For instance, a modified Gray code can be used, wherein for each position marker a minimal number of electrically conductive regions is at least present, wherein the minimal number is larger than 1. Such a modified Gray code is schematically and exemplarily shown in FIG. 6.

In this example the code has a minimum of three electrically conductive regions 83 for coding 32 positions 80 by using six code tracks 81, i.e. by using six regions per position marker, which may be covered or blank. In FIG. 6 a blank region is indicated by reference number 82.

Although in the above described embodiment the digital code of a position marker is formed by a sequence of electrically conductive and electrically insulated regions, in other embodiments the digital code can also be formed in another way. For example, a digital code of a position marker can be formed by a sequence of a) hole positions or indentation positions and b) non-hole positions or non-indentation positions, respectively. The holes or indentations can be generated by machining away a material, whereas at a non-hole position or a non-indentation position the material has not been machined away. The material is, for instance, a carrier material of the track or another material which has been attached to the track.

The reading unit can be adapted to read out the positional information from the respective position marker electrically, for instance as described above, and/or mechanically, optically or magnetically. In particular, the reading unit can be adapted to read the digital code electro-mechanically. If the digital code of a position marker is formed by a sequence of a) hole positions or indentation positions and b) non-holes positions or non-indentation positions, the reading unit can comprise spring contacts that are configured to only engage where the corresponding material has not been removed. The reading unit can also comprise other kinds of contacts like brushes, contacting needles, et cetera. The reading unit may also comprise switching contacts to “feel” the valley where the material has been removed. The reading unit can also be adapted to read the position markers capacitively or inductively. In particular, the reading unit can comprise inductive proximity switches, for example, as used in the industry to detect an end of a movement space. The inductive proximity switches may use a coil carrying a high-frequency AC current, which grows, whenever a conductive material is in proximity of the generated magnetic field, due to the resulting eddy currents in the material. In this example the position markers may be formed by a sequence of regions with protruding conductive material and regions with holes, wherein in case of a region with a protruding conductive material the current increases and in case of a region with a hole the current decreases. In a further example the reading unit may be adapted to read out positional information represented by a position marker based on a changing inductance technique, which uses ferritic material near to a coil with a core. For instance, the track may be made of iron, wherein a position marker can be formed by a sequence of regions having protruding features and regions, which do not have such protruding features. The reading unit can comprise a coil with a U-shaped core, wherein a region having a protruding iron feature can be detected, if the protruding feature, i.e. the protruding part, gets near to closing the U-shaped core of the reading unit. In a further example regions having a protruding part can capacitively be detected based on a change in capacity of a capacitive sensor caused by the protruding part.

For magnetically reading out the positional information the reading unit may comprise magnetic means like an inductor, a Hall effect sensor, a magneto-resistive sensor, et cetera. The positional information may be provided by providing regions with local magnetization and regions without local magnetization.

For optically reading out the positional information the reading unit can comprise optical means like a reflective light barrier, a camera, a line photodetector, an array of photosensitive elements, et cetera. For instance, the reading unit may comprise a light barrier system for reading out the positional information based on a detected reflectance. A single lamp device may be used for illuminating all regions defining a position marker, wherein multiple sensing elements may be used to separately measure the reflectance of each region of the respective position marker. For allowing the reading unit to optically read out the positional information, the position markers can be realized by laser marking or printing a contrasting position code pattern on, for instance, a white background material. The position markers may also comprise punch through holes, wherein the reading unit may comprise a multi-channel transmission light barrier system for reading out the positional information based on a detected transmission.

For mechanically reading out the positional information the reading unit can comprise switches. For instance, a position marker can be defined by a sequence of holes and protrusions on the track, wherein the switches may be activated and deactivated by holes and protrusions, respectively.

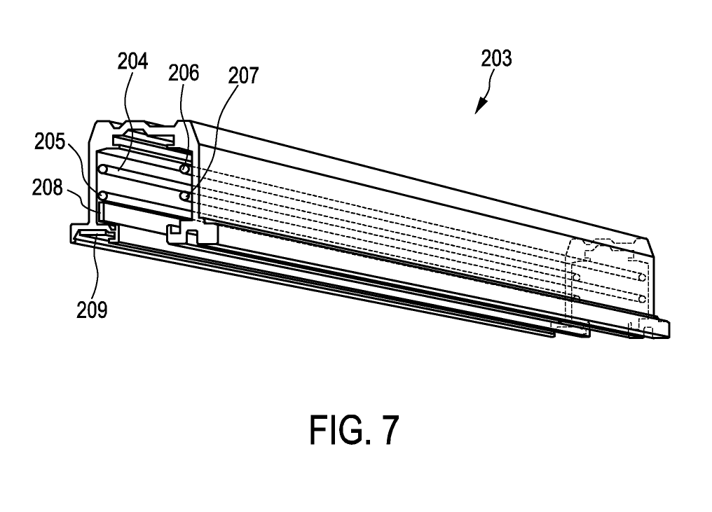

Although above with reference to FIG. 2 a certain track has been described, the power distribution track system can also comprise another type of track like the track schematically and exemplarily shown in FIG. 7. The track 203 shown in FIG. 7 is substantially U-shaped and comprises four inner electrical conductors 204 . . . 207 for distributing DC power. Coding structures 208, 209 can be attached or they can be integrated with the track 203. The track 203 can comprise only one of the coding structures 208, 209 or both coding structures 208, 209. The coding structures 208, 209 can be similar to the coding structure 20 described above with reference to FIG. 2, i.e. also in this embodiment a Gray code can be used for coding the respective longitudinal position. The coding structures can also be adapted to provide another coding like the above described modified Gray code.

If the track is formed as schematically and exemplarily shown in FIG. 7, the electrical connectors for electrically connecting electrical devices to the track are of course correspondingly configured such that at least two of the electrical conductors 204 . . . 207 are electrically connected with the respective electrical device and that the positional information represented by the coding structure 208 and/or 209 can be read out.

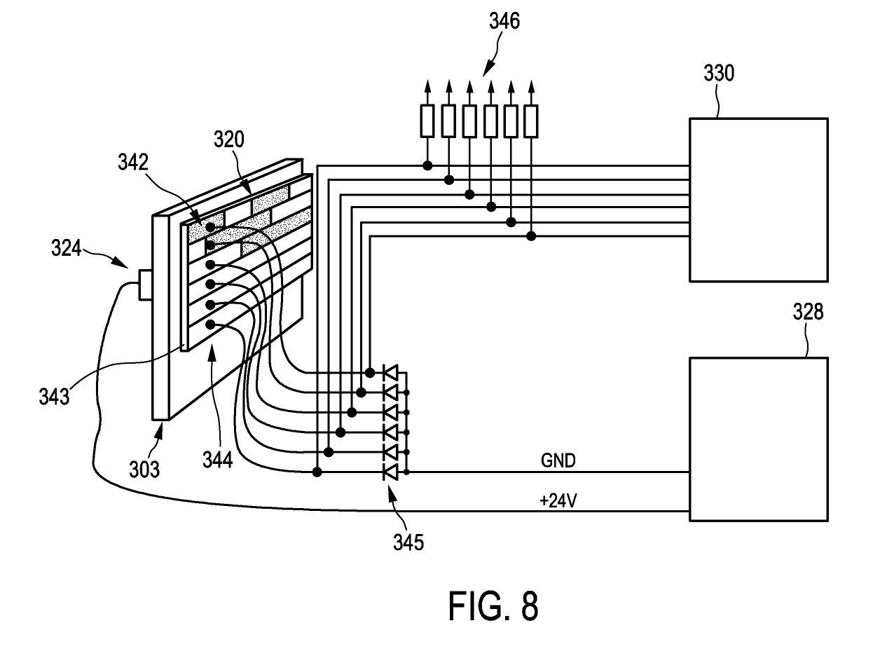

Although in above described embodiments the electrical conductors for providing the DC power and the coding structure providing the position markers are separate elements, they can also be integrated such that an electrical conductor for providing the DC power may also be used for providing the position markers. For instance, as schematically and exemplarily shown in FIG. 8, a track 303 may comprise a first electrical conductor 324 for providing a voltage of, for instance, +24 V and a second broader flat conductor 343 for the other pole of a power supply 328 of a DC power source. The second conductor 343 is electrically connected to the ground or 0 V pole of the power supply 328 via decoupling diodes 345. The flat second conductor 342 is partly covered by an electrically insulating layer 342 for providing a digital code of a position marker formed by a sequence of electrically conductive and electrically insulated regions. The second conductor 343 forms together with the electrically insulating layer 342 a coding structure 320.

The DC power source further comprises a reading unit 330 for reading out the positional information represented by the position marker, i.e. the sequence of electrically conductive and electrically insulated regions, at the longitudinal position at which the DC power source is connected to the track 303. The reading unit 330 is electrically connected to the electrically insulated and electrically conductive regions via contact elements 344 like needles. Pull-up resistors 346 are provided, in order to define the level for the contact elements 344, which do not get into contact with the ground level. For instance, the pull-up resistors 346 can be adapted to define a level of +5 V for the needles, which do not get into contact with the ground level. The pull-up resistors 346 are internal pull-up resistors or external pull-up resistors.

The arrangement schematically illustrated in FIG. 8 allows to use the same conductor and the same needles for power transport and for providing positional information. Also in this embodiment preferentially the modified Gray code is used, in order to guarantee that not the complete supply current needs to go through a single contact element 344. In this example minimally three contact elements 344 are in contact with the second conductor 343.

Although the electrical connector for electrically connecting the electrical device to the track for allowing the electrical device to receive power from or provide power to the track preferentially comprises the reading unit for reading out the positional information represented by the respective position marker, i.e. since preferentially, for example, the code pick-up element is directly integrated with the power pick-up element, in another embodiment the reading unit may not be integrated in the electrical connector, i.e. there may be some distance of, for instance, some centimeters between the reading unit and the respective position maker. For example, the reading unit can be adapted to optically detect the position marker, wherein in this case the reading unit, which may also be regarded as being an optical pick-up unit, may be attached to a ceiling tile or a luminair.

Although in the embodiment described above with reference to FIG. 2, the electrical connector 18 electrically contacts the electrical conductors 21, 22 with the track 3, wherein the electrical conductors 21, 22 are electrically connected to an electrical load of an electrical device like a lighting device, in another embodiment the electrical connector can also directly electrically connect the track with the electrical load of the electrical device.

If the reading unit is integrated in the electrical connector and if the electrical connector is directly integrated in the electrical device, the determined position is the position of the electrical device in a strict sense and can therefore directly be used for, for instance, binding sensing devices and lighting devices during a commissioning procedure. Moreover, if the DC power source comprises several channels, wherein each track is electrically connected to a certain channel, the determined position of the electrical connector can be used for informing, which channel of the DC power source is loaded electrically and where the different electrical connectors are placed, in order to determine the current distribution in the tracks. This information may be used, in order to guide an installer during an installation process or in order to inform the installer, for instance, at which place a ceiling tile needs to be opened to access a proper electrical connector.

Although in the above described embodiments the tracks comprise certain coding structures for providing the position markers at the longitudinal positions, the tracks can also comprise other coding structures providing the position markers at the longitudinal positions. For instance, in FIG. 2 the coding structure may also be provided inside the substantially U-shaped lower part 40 of the track 3, wherein, for instance, the electrical conductor 27 or the electrical conductor 26 may be partly covered with an electrically insulating layer for providing the electrically insulating and electrically conducting regions. In this case the reading unit may use miniaturized needles for contacting the different regions.

The power distribution track system is preferentially a track mounted lighting system which may be installed in office buildings, retail buildings, et cetera. The power distribution track system is preferentially a ceiling system based on carrying bars, i.e. carrying tracks, like the EMerge ceiling systems. The power distribution track system can also be adapted to comprise lighting devices connected to tracks like spot lighting devices in shops. The power distribution system can also be adapted to form a trunk lighting system.

Although in above described embodiments the electrical devices, of which the positions are determined, are, for instance, lighting devices, sensing devices or ventilation devices, the electrical devices, of which the positions are determined, can also be other types of electrical devices like power injectors, data communication devices, et cetera.

The power distribution track system is preferentially adapted to allow for an automatic determination of the positions of the electrical devices connected to the track and for a control of these electrical devices depending on their positions, i.e. the power distribution track system preferentially allows for automatic commissioning. The control can consider, for instance, the positions of the lighting devices and also the positions of other components like windows, a possible projection surface on which a beamer projects information, the position of the beamer, et cetera. The positions of the windows and the projection surface can be manually input into the control unit, whereas the positions of the electrical devices attached to the power distribution track system can be automatically determined as described above. The control unit can also be adapted to control the electrical devices, in particular, the lighting devices, depending on the desired use of the room, in which the power distribution track system is installed. The actual use can be input by a user into the control unit.

The power distribution track system is preferentially adapted to observe the presence and position of at least some components, in particular, of all components attached to the tracks of the power distribution track system, wherein this information can be used for auto-commissioning purposes or to automatically adapt control rules, when electrical devices get relocated. The control can be based on relative position information like distances between components or sequences of components and also on absolute position information. The control can be performed such that the energy is most efficiently used by the power distribution track system.

Traditional track lighting systems provide a mechanical fixation of the lighting devices and optionally other electrical devices like sensing devices, data communication device, et cetera to the tracks and the powering of these devices. However, they lack position coding features. Thus, for traditional track lighting systems positional information like the absolute position, the distance between components, et cetera of installed electrical devices has to be, for example, programmed or listed manually, thereby requiring a relative long commissioning time. In contrast, the power distribution track system described above with reference to, for instance, FIGS. 1 to 4 allows for auto-commissioning without requiring an installer to manually input the positions of the electrical devices.

Although in above described embodiments the positional information being indicative of the respective longitudinal position is used for determining the position of the respective electrical device, the positional information being indicative of the respective longitudinal position may also just be read out and used to set an address, which the power distribution track system may be used for addressing control commands to the electrical device, wherein in this example the power distribution track system comprises a control unit for controlling the electrical device via a wired or wireless communication system.

The individual track lines of the coding structure, for instance, the lines represented in FIG. 3 by reference signs A . . . F can be “hard coded” within the coding structure 20. Alternatively, one or more of the track lines may be used to code further data in a configurable manner, i.e. a part of the coding structure may be configurable.

Although in above described embodiments the coding structure shown, for instance, in FIGS. 3 and 6 comprise a certain number of regions, which may also be regarded as being coding channels, in other embodiments the coding structure can have another number of regions, in order to allow for a decreased or increased number of coded positions.

Although in above described embodiments a position marker is defined by a sequence of electrically conductive and electrically insulated regions, wherein an electrically conductive layer is partly covered with an electrically insulating layer for providing the different regions, in another embodiment electrically conductive and electrically non-conductive regions can also be provided in another way. For example, a conducting material can be provided, which is partly removed, in order to provide electrically conductive and electrically non-conductive regions.

Other variations to the disclosed embodiments can be understood and effected by those skilled in the art in practicing the claimed invention, from a study of the drawings, the disclosure, and the appended claims.

In the claims, the word “comprising” does not exclude other elements or steps, and the indefinite article “a” or “an” does not exclude a plurality.

A single unit or device may fulfill the functions of several items recited in the claims. The mere fact that certain measures are recited in mutually different dependent claims does not indicate that a combination of these measures cannot be used to advantage.

Procedures like the determination of the position of the respective electrical device and the control of the electrical device performed by one or several units or devices can be performed by any other number of units or devices. These procedures and/or the control of the power distribution track system in accordance with the position determining method can be implemented as program code means of a computer program and/or as dedicated hardware.

A computer program may be stored/distributed on a suitable medium, such as an optical storage medium or a solid-state medium, supplied together with or as part of other hardware, but may also be distributed in other forms, such as via the Internet or other wired or wireless telecommunication systems.

1. A power distribution track system for distributing power via a track, the power distribution track system comprising:
the track, wherein the track comprises position markers at different longitudinal positions along the track, wherein the position markers represent positional information being indicative of the respective longitudinal position,
an electrical device connected to the track at a longitudinal position, wherein the electrical device comprises a reading unit for reading out the positional information represented by the position marker at the longitudinal position at which the electrical device is connected.

2. The power distribution track system as defined in claim 1, wherein the position markers form digital codes for indicating the respective longitudinal position.

3. The power distribution track system as defined in claim 2, wherein the digital code of a position marker is formed by a sequence of electrically conductive regions and electrically insulated regions.

4. The power distribution track system as defined in claim 3, wherein for each position marker a minimal number of electrically conductive regions is at least present, wherein the minimal number is larger than one.

5. The power distribution track system as defined in claim 2, wherein the digital code of a position marker is formed by a sequence of a) hole positions or indentation positions and b) non-hole positions or non-indentation positions.

6. The power distribution track system as defined in claim 1, wherein the position markers form a Gray code.

7. The power distribution track system as defined in claim 1, wherein the power distribution track system comprises several tracks, wherein the position markers are further adapted to be indicative of the position of the respective track.

8. The power distribution track system as defined in claim 1, wherein the electrical device comprises an electrical connector for electrically connecting the electrical device to the track for allowing the electrical device to receive power from or provide power to the track, wherein the electrical connector comprises the reading unit for reading out the positional information represented by the respective position marker.

9. The power distribution track system as defined in claim 1, wherein the power distribution track system comprises a position determining device for determining the longitudinal position of the electrical device based on the positional information.

10. A track for a power distribution track system for distributing power as defined in claim 1, wherein the track comprises position markers at different longitudinal positions along the track, wherein the position markers represent positional information being indicative of the respective longitudinal position.

11. An electrical device for a power distribution track system for distributing power as defined in claim 1, wherein the electrical device is adapted to be connected to the track of the power distribution track system at a longitudinal position, wherein the electrical device comprises a reading unit for reading out the positional information at the longitudinal position at which the electrical device is connected.

12. An electrical connector for electrically connecting an electrical device of the power distribution track system defined in claim 1 to a track of the power distribution track system, wherein the electrical connector comprises a reading unit for reading out the positional information at the longitudinal position at which the electrical device is connected.

13. A position determining device for a power distribution track system as defined in claim 1, wherein the position determining device is adapted to determine the longitudinal position of the electrical device based on the positional information.

14. A position determining method for determining the position of an electrical device along a track of a power distribution track system as defined in claim 1, wherein the position determining method comprises:
reading out the positional information represented by the position marker at the longitudinal position of the track, at which the electrical device is connected, by the reading unit,
determining the longitudinal position of the electrical device based on the positional information by a position determining device.

15. A position determining computer program for determining the position of an electrical device along a track of a power distribution track system as defined in claim 1, the position determining computer program comprising program code means for causing a power distribution track system as defined in claim 1 to carry out the steps of a position determining method when the position determining computer program is run on a computer controlling the power distribution track system.
